(19) United States
(12) Patent Application Publication
(10) Pub. No.: US 2004/0122724 A1
(43) Pub. Date: Jun. 24, 2004

(54) System and method for generating priorities of manufacturing orders

(76) Inventor: Hung-Shan Wei, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/658,664

(22) Filed: Sep. 8, 2003

(30) Foreign Application Priority Data
Dec. 20, 2002 (TW) 91136968

(51) Int. Cl. G06F 17/60

(52) U.S. Cl. 705/8

(57) ABSTRACT

A system for generating priorities of manufacturing orders includes a priority calculating module (201), a priority revising module (202), a sorting module (203), and a document updating module (205). The priority calculating module is for determining calculated priorities of manufacturing orders in accordance with data on the manufacturing orders. The priority revising module is used to revise priorities of manufacturing orders to account for particular contingencies that arise, and to satisfy particular requirements or customers. The sorting module is used to display manufacturing orders in selected sequences for users. The document updating module is used to update data stored in a master list of manufacturing order (211) and in detailed records of manufacturing orders (212). A related method includes the steps of: (a) calculating a calculated priority of a manufacturing order; (b) revising a designated priority of a manufacturing order; and (c) displaying manufacturing orders in a selectable sequence.

### BACKGROUND OF THE INVENTION

1. Field of the Invention

The present invention relates to a computerized data processing system in the manufacturing industry, and especially to a system and method for managing manufacturing orders via distributed computers.

2. Background of the Invention

Globalized economic development has brought tremendous business opportunities to numerous enterprises, and also brought more pressure to bear on manufacturing enterprises. For example, more and more customized products are being ordered by a wider range of customers, and customers are requiring more rigorous quality standards and more demanding delivery deadlines. Further, an enterprise's manufacturing may be conducted in a number of different countries across the globe, making management of the enterprise a challenging task. A competitive enterprise needs to adopt new technologies, design new products, reduce manufacturing cycles of products, enhance productivity, and reduce costs. Such enterprise should also strengthen manufacturing management, such as supply of materials, product manufacturing, and merchandise distribution. The enterprise should further cooperate with suppliers, dealers, and customers to make the best of their shared and respective resources. By such means, the enterprise can achieve high customer satisfaction, and maintain keen competitiveness.

Manufacturing resource planning (MRPII) systems can assist in advancing an enterprise's competitiveness. For example, P.R. China patent application No. 01118171.0 entitled “System for Manufacturing Management” discloses an information system for manufacturing management. In this system, a network is used to connect a central processing device with a plurality of terminal devices. The central processing device processes data from the terminal devices, and sends management information to the terminal devices to manage manufacturing on a shop floor. The system can help the enterprise manufacture high quality products, enhance productivity, reduce costs of resources, and shorten manufacturing life cycles.

However, changes in a manufacturing schedule can occur at any time and for any of a variety of reasons. For example, a customer may change its orders, a supplier may change delivery times of materials, and manufacturing machinery may break down or function poorly. The enterprise may not be able to keep to its original fixed production plan. In these circumstances, the above-described information system for manufacturing management is of little value. To maintain enhanced productivity, an enterprise needs to be able to flexibly change production planning according to commercial vicissitudes.

### SUMMARY OF THE INVENTION

Accordingly, an objective of the present invention is to provide a system for generating priorities of manufacturing orders which can generate a sequence of product manufacturing.

Another objective of the present invention is to provide a method for generating priorities of manufacturing orders which can generate a sequence of product manufacturing.

In order to achieve the first above-mentioned objective, a system for generating priorities of manufacturing orders in accordance with the present invention comprises a priority calculating module, a priority revising module, a sorting module and a document updating module. The priority calculating module is for determining calculated priorities of manufacturing orders in accordance with data on the manufacturing orders. The priority revising module is used to revise priorities of manufacturing orders to account for particular contingencies that arise, and to satisfy particular requirements or customers. The sorting module is used to display manufacturing orders in selected sequences for users. The document updating module is used to update data stored in a master list of manufacturing

In order to achieve the second above-mentioned objective, a method for generating a priority of manufacturing orders in accordance with the present invention comprises the steps of: (a) calculating a calculated priority of a manufacturing order; (b) revising a designated priority of a manufacturing order; and (c) displaying manufacturing orders in a selectable sequence.

Other objects, advantages and novel features of the present invention will be drawn from the following detailed description of preferred embodiments of the present invention with the attached drawings, in which:

### BRIEF DESCRIPTION OF THE DRAWINGS

FIG. 1 is a schematic diagram of hardware configuration of a system for generating priorities of manufacturing orders in accordance with a preferred embodiment of the present invention, the system comprising a plurality of client computers, an application server, and a database server;

FIG. 2 is a block diagram of function modules of the application server and the database server, and of communication between the application server and the database server; and

FIG. 3 is a flow chart of a preferred method for generating a priority of manufacturing orders in accordance with the present invention.

### DETAILED DESCRIPTION OF PREFERRED EMBODIMENTS OF THE INVENTION

Reference will now be made to the drawings to describe the present invention in detail.

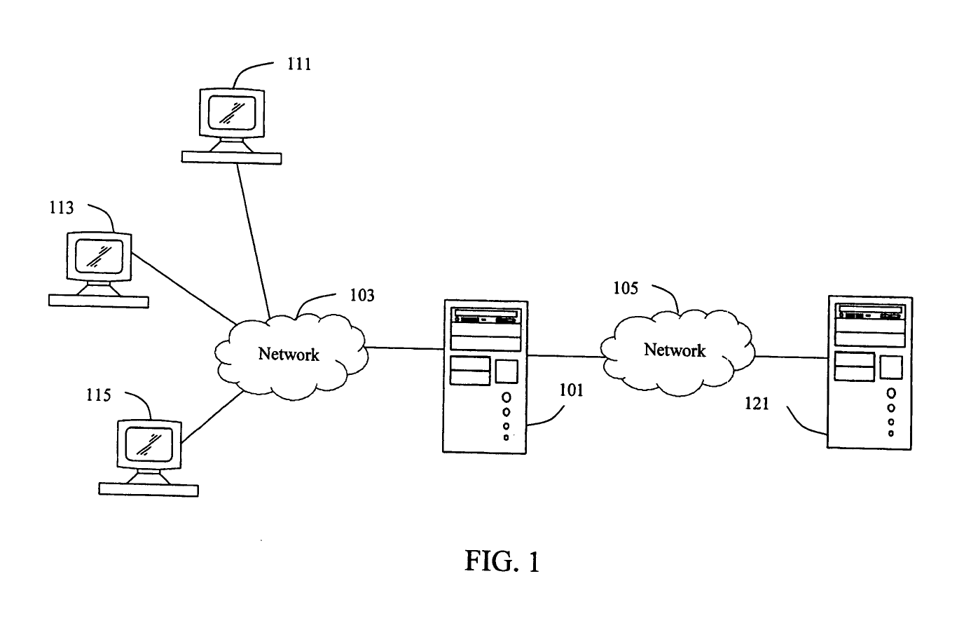

FIG. 1 is a schematic diagram of hardware configuration of a system for generating priorities of manufacturing orders in accordance with the preferred embodiment of the present invention. The system for generating priorities of manufacturing orders comprises a three-layer information system. The presentation layer information system comprises a data access layer, a business logic layer, and a presentation layer. The data access layer comprises a database server 121. The business logic layer comprises an application server 101. The presentation layer comprises a plurality of client computers. For the purposes of conveniently illustrating the preferred embodiment of the present invention, three client computers 111, 113, 115 are shown and described hereinafter. Computer communication networks 103, 105 interconnect all the above-mentioned apparatuses.

The application server 101 comprises core and mutable enterprise logic (such as rules, execution, and management) of the system for generating priorities of manufacturing orders. The application server 101 processes input by users at the client computers 111, 113, 115, and returns results of processing to the users. The database server 121 has a database located therein, which stores all structured data on an enterprise. The database server 121 is used for managing processing of the stored data. Such processing includes reading, writing, deleting, modifying, and backup. The client computers 111, 113, 115 have the function of receiving orders input by users, and displaying results of implementation of such orders. The client computers 111, 113, 115 can be simple input/output devices known in the art.

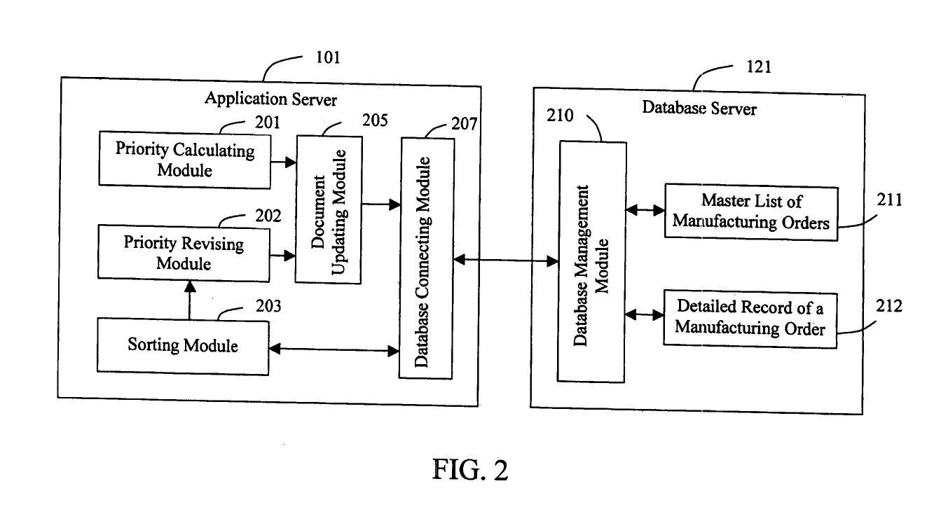

FIG. 2 is a block diagram of function modules of the application server 101 and the database server 121, and of communication between the application server 101 and the database server 121. The application server 101 includes a priority calculating module 201, a priority revising module 202, a sorting module 203, a document updating module 205, and a database connecting module 207. The database server 121 includes a database management module 210, a master list of manufacturing orders 211, and a plurality of detailed records of manufacturing orders 212 (only one shown). In the preferred embodiment of the present invention, each manufacturing order is an order to a shop floor to manufacture a fixed quantity of designated products within a fixed time.

The master list of manufacturing orders 211 comprises the following data on each manufacturing order: an ID of the manufacturing order, a category of the manufacturing order, a code of the manufacturer, a designated priority, a calculated priority, a scheduled starting time, a scheduled completion time, a mode of manufacturing scheduling, and a status of the manufacturing order. The mode of manufacturing scheduling refers to a way in which the same product or similar products are made. For example, a product may be made by adding on successive components in a particular sequence. The same or a similar product may also be made by adding on the same components successively, but in a different sequence. Each detailed record of a manufacturing order 212 comprises data on an ID of the manufacturing order, quantities of products, a calculated priority, a designated priority, scheduled manufacturing output, scheduled manufacturing starting time, scheduled manufacturing completion time, stock storage after manufacturing, actual manufacturing starting time, actual manufacturing completion time, a total quantity upon completion of manufacturing, and a quantity of residue stock. The calculated and designated priorities of manufacturing orders contain data on manufacturing sequences of manufacturing orders. The calculated priority is generating by the priority calculating module 201 in accordance with the scheduled manufacturing starting time and the scheduled manufacturing completion time of a manufacturing order. The designated priority is used to designate the priority of a manufacturing order when contingencies arise. If no data are input into the designated priority, the priority revising module 202 copies data from the calculated priority. If the designated priority is different from the calculated priority, the designated priority is used.

The priority calculating module 201 is used to determine the calculated priority of a manufacturing order in accordance with the scheduled manufacturing starting time and the scheduled manufacturing completion time of the manufacturing order. The formula for determining the calculated priority is: Calculated priority=(scheduled manufacturing completion time—current date)/(scheduled manufacturing completion time—scheduled manufacturing starting time). The value of the calculated priority is between 0.00 and 0.99. The smaller the value of the calculated priority, the higher the priority of the corresponding manufacturing order. The above formula is only a preferred embodiment of the present invention. Many other formulas can be used to calculate the priorities of manufacturing orders, and may calculate said priorities more accurately. The priority revising module 202 is used to revise priorities of manufacturing orders to account for particular contingencies that arise, and to satisfy particular requirements of customers. Revised data are stored in the designated priority. The value of the designated priority is also between 0.00 and 0.99. The sorting module 203 is used to display manufacturing orders in different sequences for a user. For example, manufacturing orders can be displayed in sequence of the designated priorities, the calculated priorities, the scheduled manufacturing starting times, or the scheduled manufacturing completion times. The document updating module 205 is used to update priority data stored in the database server 121 in accordance with data generated by the priority calculating module 201 and the priority revising module 202. This updating is done via the database connecting module 207 and the database management module 210.

The database connecting module 207 is used for connecting the application server 101 with the database server 121. The database connecting module 207 controls data communication between applications and source data. Applications of the application server 101 can access data stored in different database management systems (DBMSs) via the database connecting module 207. The database connecting module 207 can be founded on open database connectivity (ODBC). The database management module 210 is used to manage data stored in the database server 121, including data stored in the master list of manufacturing orders 211 and the detailed records of manufacturing orders 212.

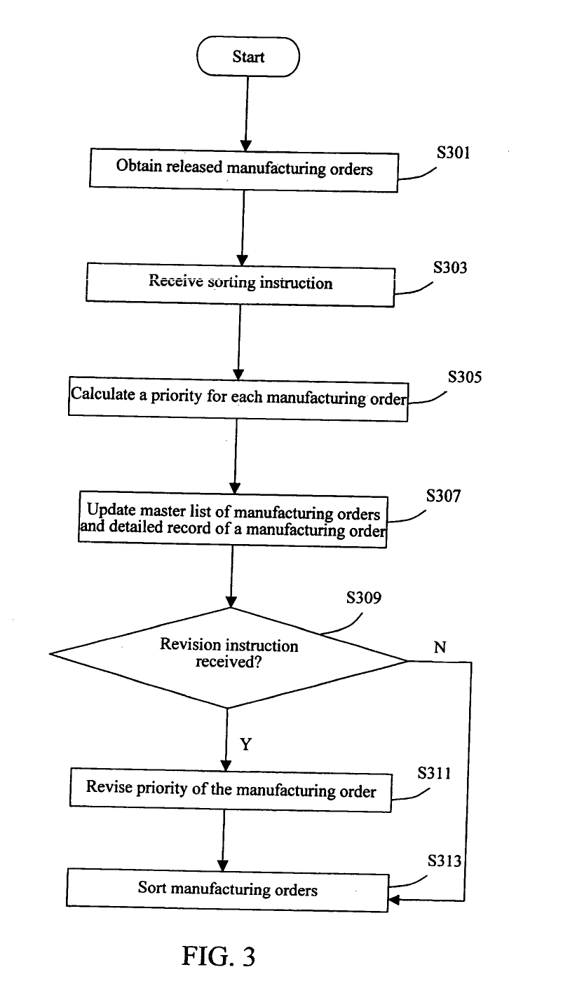

FIG. 3 is a flow chart of a preferred method for generating a priority of manufacturing orders in accordance with the present invention. Firstly, in step S301, the application server 101 obtains released manufacturing orders from an MRPII (Manufacture Resource Planning II) system. The manufacturing orders are input by a user, and stored in the master list of manufacturing orders 211 and the detailed records of manufacturing orders 212.

In step S303, the sorting module 203 receives a manufacturing order sorting instruction input by the user via a GUI (Graphical User Interface). The sorting instruction can be for displaying of designated manufacturing orders in a particular sequence. The particular sequence can be sorting the manufacturing orders in accordance with the calculated priorities, the designated priorities, or codes of the manufacturing orders. In step S305, for each manufacturing order, the priority calculating module 201 reads data on the scheduled manufacturing starting time and the scheduled manufacturing completion time from the relevant detailed record of a manufacturing order 212 via the database connecting module 205 and the database management module 210, and determines the calculated priority of the manufacturing order. In step S307, the document updating module 205 stores the obtained data in the calculated priority and the designated priority of the relevant detailed record of a manufacturing order 212, and in the master list of manufacturing orders 211.

In step S309, the priority revising module 202 of the application server 101 can receive a revision instruction input by the user via any of the client computers 111, 113, 115. The revision instruction is for the purpose of accounting for a particular contingency that has arisen, or for satisfying a particular requirement of a customer. If no revision instruction is received, the procedure proceeds directly to step S313 described below. If a revision instruction is received, in step S311, the priority revising module 202 revises the priority of the relevant manufacturing order, and the document updating module 205 stores revision data in the designated priority of the relevant manufacturing order. In step S313, the sorting module 203 displays the manufacturing orders in sequence in accordance with the user's sorting instruction.

Although only preferred embodiments of the present invention have been described in detail above, those skilled in the art will readily appreciate that many modifications to the preferred embodiments are possible without materially departing from the novel teachings and advantages of the present invention. Accordingly, all such modifications are deemed to be covered by the following claims and allowable equivalents of the claims.

What is claimed is:

1. A system for generating priorities of manufacturing orders, the system comprising a priority calculating module, a priority revising module, a sorting module and a document updating module, wherein:
the priority calculating module is used to determine calculated priorities of manufacturing orders in accordance with data on the manufacturing orders;
the priority revising module is used to revise priorities of manufacturing orders to requirements of customers;
the sorting module is used to display manufacturing orders in selected sequences for users; and
the document updating module is used to update priority data stored in a database server according to data generated by the priority calculating module and the priority revising module.

2. The system as claimed in claim 1, wherein the priority calculating module, the priority revising module, the sorting module and the document updating module are comprised in an application server.

3. The system as claimed in claim 1, further comprising a database connecting module which connects the priority calculating module, the priority revising module, the sorting module and the document updating module with a master list of manufacturing orders and detailed records of manufacturing orders.

4. The system as claimed in claim 3, wherein the master list of manufacturing orders and the detailed records of manufacturing orders are comprised in a database server.

5. The system as claimed in claim 4, wherein the database server comprises a database management module for managing the master list of manufacturing orders and the detailed records of manufacturing orders.

6. The system as claimed in claim 1, wherein selectable sequences for displaying manufacturing orders comprise sequences according to a designated priority, a calculated priority, a scheduled manufacturing starting time, and a scheduled manufacturing completion time.

7. The system as claimed in claim 3, wherein the document updating module updates data stored in the master list of manufacturing orders and the detailed records of manufacturing orders in accordance with implementation results of the priority calculating module and the priority revising module.

8. The system as claimed in claim 1, wherein the calculated priority is determined using the formula: Calculated priority=(scheduled manufacturing completion time—current date)/(scheduled manufacturing completion time—scheduled manufacturing starting time).

9. A method for generating a priority of manufacturing orders, the method comprising the steps of:
determining a calculated priority of a manufacturing order;
revising a designated priority of a manufacturing order; and
displaying manufacturing orders in a selectable sequence.

10. The method as claimed in claim 9, further comprising the step of updating a master list of manufacturing orders and a detailed record of the manufacturing order.

11. The method as claimed in claim 9, wherein the determining step relates to a scheduled manufacturing starting time and a scheduled manufacturing completion time of the manufacturing order.

12. A process of generating priorities of manufacturing orders, comprising steps of:
obtaining released manufacturing orders;
receiving sorting instructions;
calculating a priority of each of said manufacturing orders;
updating a master list of manufacturing orders and detailed records of each of said manufacturing orders;
sorting manufacturing orders if no revision instructions are received, or revising priorities of the manufacturing orders and then sorting said revised priorities of the manufacturing orders if revision instructions are received.
